(19) United States
(12) Patent Application Publication
(10) Pub. No.: US 2021/0097949 A1
(43) Pub. Date: Apr. 1, 2021

(54) METHOD AND DEVICE FOR DRIVING DISPLAY PANEL, AND LIQUID CRYSTAL DISPLAY DEVICE

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Peng Qin, Beijing (CN); Cheng Zuo, Beijing (CN); Kangpeng Dang, Beijing (CN); Zhong Jin, Beijing (CN); Bo Wang, Beijing (CN); Yang Rao, Beijing (CN); Xiong Guo, Beijing (CN); Zhongli Luo, Beijing (CN); Yuansheng Tang, Beijing (CN); Teng Liu, Beijing (CN); Shifei Huang, Beijing (CN); Lihua Jiang, Beijing (CN); Xinxi He, Beijing (CN); Hong Chen, Beijing (CN)

(21) Appl. No.: 16/838,774

(22) Filed: Apr. 2, 2020

(30) Foreign Application Priority Data
Sep. 27, 2019 (CN) 201910920843.6

(51) Int. Cl. G09G 3/36

(52) U.S. Cl. CPC G09G 3/3614; G09G 2310/0243; G09G 2300/0823; G09G 3/3688

(57) ABSTRACT

A method and a device for driving a display panel, and a liquid crystal display device are provided. The method includes: controlling polarities of output voltages of data driving circuits corresponding to at least two adjacent pixels in a row of a pixel array of the display panel to be same. The adjacent pixels comprise a pixel in a bright state and a pixel in a dark state, and an absolute value of the output voltage of the data driving circuit corresponding to the pixel in the bright state is greater than an absolute value of the output voltage of the data driving circuit corresponding to the pixel in the dark state.

### CROSS-REFERENCE TO RELATED APPLICATIONS

This application claims the priority of Chinese patent application No. 201910920843.6 filed on Sep. 27, 2019, the contents of which are entirely incorporated herein by reference.

### TECHNICAL FIELD

The present disclosure relates to the field of display technology, and in particular, to a method and a device for driving a display panel, and a liquid crystal display device.

### BACKGROUND

In some Liquid Crystal Display (LCD) devices, such as Thin Film Transistor—Liquid Crystal Display (TFT-LCD) devices, display panels are generally driven by employing a drive mode of Z-inversion. The so called “Z-inversion” is a drive mode in which a dot inversion is achieved by a column inversion.

In some cases, such as in the process of testing display qualities, the LCD device needs to display a heavy-load image. The heavy-load image refers to an image in which bright portions and dark portions are alternately arranged. For example, a sub-v-line image is a kind of heavy-load image, and has columns of the pixels in the bright state alternated with columns of the pixels in the dark state. In other words, the display panel of the LCD device displays, in an alternate way, a column of pixels in the bright state, a column of pixels in the dark states, a column of pixels in the bright state, a column of pixels in the dark states, and so on.

The inventors have found that: if the Z-reversion is used in the LCD to drive the display panel to display the heavy-load image (such as a sub-v-line image) having columns of the pixels in the bright state alternated with columns of the pixels in the dark state, a data driving circuit has a large load.

### SUMMARY

In view of the above, embodiments of the present disclosure are to provide a method and a device for driving a device panel, and an LCD device, in order to reduce the load of the data driving circuit.

In view of above, an embodiment of the present disclosure provides a method for driving a display panel. The method includes: controlling polarities of output voltages of data driving circuits corresponding to at least two adjacent pixels in a row of a pixel array of the display panel to be same. The adjacent pixels include a pixel in a bright state and a pixel in a dark state. An absolute value of the output voltage of the data driving circuit corresponding to the pixel in the bright state is greater than an absolute value of the output voltage of the data driving circuit corresponding to the pixel in the dark state.

Optionally, in the row of the pixel array, absolute values of the output voltages of the data driving circuits corresponding to the pixels in the bright state are same, and not all polarities of the output voltages of the data driving circuits corresponding to the pixels in the bright state are same.

Optionally, there is a plurality of pixel groups in the row, each of the pixel groups includes at least two pixels, and a sequence of the output voltages of the data driving circuits corresponding to at least two pixels of one of the pixel groups is same as a sequence of the output voltages of the data driving circuits corresponding to at least two pixels of another one of the pixel groups.

Optionally, the pixels in each of the pixel groups are adjacent to each other, and the number of the pixels in each of the pixel group is an even number.

Optionally, in the row of the pixel array, absolute values of the output voltages of the data driving circuits corresponding to the pixels in the dark state are same, and not all polarities of the output voltages of the data driving circuits corresponding to the pixels in the dark state are same.

Optionally, each of the pixel groups includes six pixels, and a first one of the six pixels is a pixel in the bright state. The step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be negative; and controlling a polarity of the output voltage of the data driving circuit corresponding to a sixth pixel in the pixel group to be negative.

Optionally, the pixel array further includes another row adjacent to the row, and the method further includes: controlling a polarity of the output voltage of the data driving circuit corresponding to a pixel in the another row adjacent to the first pixel to be negative; controlling a polarity of the output voltage of the data driving circuit corresponding to a pixel in the another row adjacent to the second pixel to be positive; controlling a polarity of an output voltage of a data driving circuit corresponding to a pixel in the another row adjacent to the third pixel to be positive; controlling a polarity of an output voltage of a data driving circuit corresponding to a pixel in the another row adjacent to the fourth pixel to be negative; controlling a polarity of the output voltage of the data driving circuit corresponding to a pixel in the another row adjacent to the fifth pixel to be positive; and controlling a polarity of the output voltage of the data driving circuit corresponding to a pixel in the another row adjacent to the sixth pixel to be positive.

Optionally, each of the pixel groups includes six pixels, and a first one of the six pixels is a pixel in the bright state; and the step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be positive; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be positive; and a polarity of the output voltage of the data driving circuit corresponding to a sixth pixel in the pixel group to be negative.

Optionally, the pixel array further includes another row adjacent to the row, and the method further includes: controlling a polarity of the output voltage of the data driving circuit corresponding to a pixel in the another row adjacent to the first pixel to be negative; controlling a polarity of the output voltage of the data driving circuit corresponding to a pixel in the another row adjacent to the second pixel to be negative; controlling a polarity of an output voltage of a data driving circuit corresponding to a pixel in the another row adjacent to the third pixel to be positive; controlling a polarity of an output voltage of a data driving circuit corresponding to a pixel in the another row adjacent to the fourth pixel to be negative; controlling a polarity of the output voltage of the data driving circuit corresponding to a pixel in the another row adjacent to the fifth pixel to be negative; and controlling a polarity of the output voltage of the data driving circuit corresponding to a pixel in the another row adjacent to the sixth pixel to be positive.

Optionally, each of the pixel groups includes six pixels, and a first one of the six pixels is a pixel in the bright state; and the step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be positive; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be negative; and controlling a polarity of the output voltage of the data driving circuit corresponding to a sixth pixel in the pixel group to be positive.

Optionally, each of the pixel groups includes six pixels, and a first one of the six pixels is a pixel in the bright state; and the step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be negative; controlling a polarity of the output voltage of the data driving circuit corresponding to a fifth pixel in the pixel group to be negative; and controlling a polarity of the output voltage of the data driving circuit corresponding to a sixth pixel in the pixel group to be negative.

Optionally, each of the pixel groups includes six pixels, and a first one of the six pixels is a pixel in the bright state; and the step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be positive; a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be positive; and controlling a polarity of the output voltage of the data driving circuit corresponding to a sixth pixel in the pixel group to be positive.

Optionally, each of the pixel groups includes six pixels, and a first one of the six pixels is a pixel in the bright state; and the step of controlling the polarities of the output voltages of the data driving circuits corresponding to the at least two adjacent pixels in the row to be same includes: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be negative; controlling a polarity of the output voltage of the data driving circuit corresponding to a fifth pixel in the pixel group to be positive; and controlling a polarity of the output voltage of the data driving circuit corresponding to a sixth pixel in the pixel group to be negative.

Optionally, the output voltage of the data driving circuit is in a range of gamma voltages V1-V14, wherein a polarity of each of the gamma voltages V1-V7 is positive, a polarity of each of the gamma voltages V8-V14 is negative; the output voltage of the data driving circuit corresponding to the pixel in the bright state is the gamma voltage V1 or the gamma voltage V14; and the output voltage of the data driving circuit corresponding to the pixel in the dark state is the gamma voltage V7 or the gamma voltage V8.

Optionally, absolute values of the output voltages of the data driving circuits corresponding to the pixels located in a same column and respectively in adjacent two rows of the pixel array are same, and polarities of the output voltages of the data driving circuits corresponding to the pixels located in the same column and respectively in the adjacent two rows of the pixel array are opposite to each other.

Optionally, a heavy-load image having columns of the pixels in the bright state alternated with columns of the pixels in the dark state in the pixel array is displayed by using a Z-inversion mode, and in the row, the pixels in the bright state are alternately arranged with the pixels in the dark state.

In view of above, an embodiment of the present disclosure further provides a device for driving a display panel. The device includes: a timing control circuit and a data driving circuit corresponding to each of the pixels. The timing control circuit is configured to implement the any of above methods for driving the display panel.

In view of above, an embodiment of the present disclosure further provides a LCD device. The LCD device includes: a display panel, a graphics card, a timing control circuit, and a data driving circuit corresponding to each of the pixels. The graphics card is configured to transmit to-be-displayed data to the timing control circuit. The timing control circuit is configured to determine whether the to-be-displayed data corresponds to an heavy-load image having columns of pixels in a bright state alternated with columns of pixels in a dark state; and when the to-be-displayed data corresponds to the heavy-load image having the columns of the pixels in the bright state alternated with the columns of the pixels in the dark state, implement the any of above methods for driving the display panel.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a schematic diagram showing a scenario where Vcom is pulled, according to an embodiment of the present disclosure;

FIG. 2 is a schematic diagram of a driving method according to an embodiment of the present disclosure;

FIG. 3 is a schematic diagram of another driving method according to an embodiment of the present disclosure;

FIG. 4 is a schematic diagram of yet another driving method according to an embodiment of the present disclosure;

FIG. 5 is a schematic diagram of still yet another driving method according to an embodiment of the present disclosure;

FIG. 6 is a schematic diagram of still yet another driving method according to an embodiment of the present disclosure;

FIG. 7 is a schematic diagram of still yet another driving method according to an embodiment of the present disclosure; and

FIG. 8 is a schematic diagram of a signal processing logic according to an embodiment of the present disclosure.

### DETAILED DESCRIPTION

In order to make objects, technical solutions and advantages of the present disclosure more clear, the present disclosure is further described in detail below in conjunction with specific embodiments along with the accompanying drawings.

It should be noted that all the expressions “first” and “second” used in embodiments of the present disclosure are merely intended for distinguishing two different entities or different parameters having the same name. Accordingly, the expressions “first” and “second” are only used for the purpose of ease of illustration, but not be understood as a limitation to the embodiments of the present disclosure, which will not be explained repeatedly in subsequent embodiments.

Interpretation of Terms.

Z-inversion mode: a drive mode in the TFT-LCD structure in which a dot inversion is achieved by a column inversion. Optionally, in the Z-inversion mode, TFTs and pixel electrodes may be alternately disposed on left sides and right sides of data lines, and the data voltages are provided to the data lines based on the column inversion system. The Z-inversion system can be considered as an improved structure of the column inversion system. The circuit driving method of the Z-inversion system uses a column inversion, and displays the image in a similar way to the dot inversion system.

Sub v line heavy-load image: an image having columns of the pixels in the bright state alternated with columns of the pixels in the dark state.

Vcom: a common voltage, or referred to as a reference voltage of the pixel voltage;

Gamma voltage: in the embodiments of the present disclosure, the gamma voltages will be equally divided into fourteen portions, represented by gamma voltages V1-V14. A polarity of each of the gamma voltages V1-V7 is positive, a polarity of each of the gamma voltages V8-V14 is negative. The values of the positive voltages V1-V7 gradually decreases from V1 to V7, and the absolute values of the negative voltages V8-V14 gradually decreases from V14 to V8. Theoretically, |V1−Vcom| and |V14−Vcom| are same, |V2−Vcom| and |V13−Vcom| are same, and so on. Optionally, the absolute values of V1 and V14 are same, the absolute values of V2 and V13 are same, the absolute values of V3 and V12 are same, the absolute values of V4 and V11 are same, the absolute values of V5 and V10 are same, and the absolute values of V6 and V9 are same, and the absolute values of V7 and V8 are same.

The inventors have found that: in the related art, when the display panel of the LCD device such as TFT-LCD employs a Z-inversion mode to display sub-v-line heavy-load image, with respect to a same pixel row of the pixel array, each of the voltage values corresponding to the pixels in the bright state is the positive gamma voltage V1, and each of the voltage values corresponding to the pixels in the dark state is the negative gamma voltage V8. That is, the voltage values between adjacent pixels in the same row vary greatly, and change from the positive gamma voltage V1 to the negative gamma voltage V8 and then to the positive gamma voltage V1, which causes a large load on the data driving circuit.

In some cases, because the data driving circuit requires a large driving current, the data driving circuit needs to obtain a large current output from a power Integrated Circuit (IC). The increase of the current output would cause the entire loop voltage drop V_{drop}=I*R of the entire circuit to be increased. However, the voltage of the external power supply is generally constant at 3.3V, so that it will cause the reduced actual voltage of the IC due to the increase of the V_{drop}, which would force the IC to enter a low voltage protection state, resulting in an abnormally displayed image.

To solve this technical problem, embodiments of the present disclosure provide a method and a device for driving a display panel, and a LCD device. With this technical solution, when the Z-inversion mode is employed to drive the display panel of the LCD device for displaying the sub-v-line heavy-load image, polarities of output voltages of data driving circuits corresponding to at least two adjacent pixels in a row of a pixel array of the display panel are controlled to be same. That is, there are a pixel in the bright state and a pixel in dark state which are adjacent to each other in a row and have the same voltage polarity. As compared to the conversion from V1 to V8 in the related art, a change in the voltage between adjacent pixels in the same row is relatively small according to the embodiments of the present disclosure, thereby reducing the load on the data driving circuit, which further reduce occurrence of abnormal image caused by the overload.

The method for driving a display panel of a LCD device according to an embodiment of the present disclosure is described in detail below. The method includes: controlling, when a Z-inversion mode is used to display a sub-v-line heavy-load image, polarities of output voltages of data driving circuits corresponding to at least two adjacent pixels in a row of a pixel array of the display panel to be same. The adjacent pixels include a pixel in a bright state and a pixel in a dark state, and an absolute value of the output voltage of the data driving circuit corresponding to the pixel in the bright state is greater than an absolute value of the output voltage of the data driving circuit corresponding to the pixel in the dark state. Optionally, the pixels in the light state are alternately arranged with the pixels in the dark state in the row.

For example, each of the polarities of the output voltages of the data driving circuits corresponding to the at least two adjacent pixels may be positive. Such example are as follows: the output voltage of the data driving circuit corresponding to the pixel in the bright state may be V1, and the output voltage of the data driving circuit corresponding to the pixel in the dark state may be V7; or the output voltage of the data driving circuit corresponding to the pixel in the bright state may be V1, and the output voltage of the data driving circuit corresponding to the pixel in the dark state may be V6; or the output voltage of the data driving circuit corresponding to the pixel in the bright state may be V2, and the output voltage of the data driving circuit corresponding to the pixel in the dark state may be V6, as long as an absolute value of the output voltage of the data driving circuit corresponding to the pixel in the bright state is greater than an absolute value of the output voltage of the data driving circuit corresponding to the pixel in the dark state.

For another example, each of the polarities of the output voltages of the data driving circuits corresponding to the at least two adjacent pixels may be negative. Such example are as follows: the output voltage of the data driving circuit corresponding to the pixel in the bright state may be V14, and the output voltage of the data driving circuit corresponding to the pixel in the dark state may be V8; or the output voltage of the data driving circuit corresponding to the pixel in the bright state may be V4, and the output voltage of the data driving circuit corresponding to the pixel in the dark state may be V9; or the output voltage of the data driving circuit corresponding to the pixel in the bright state may be V13, and the output voltage of the data driving circuit corresponding to the pixel in the dark state may be V9, as long as an absolute value of the output voltage of the data driving circuit corresponding to the pixel in the bright state is greater than an absolute value of the output voltage of the data driving circuit corresponding to the pixel in the dark state.

In an embodiment, in one pixel row of the pixel array, absolute values of the output voltages of the data driving circuits corresponding to the pixels in the bright state are same, and not all polarities of the output voltages of the data driving circuits corresponding to the pixels in the bright state are same.

The inventors have also found that: in the related art, each of the voltage values corresponding to the pixels in the bright state is the V1 with the positive polarity, so that the voltage difference of |V1−Vcom| decreases due to the Vcom value being pulled up by capacitive characteristics, thereby decreasing the brightness of the displayed image.

Take a row of pixels as an example. As shown in FIG. 1, it is assumed that when a current image frame is displayed, each of the output voltages of the data driving circuits corresponding to all the pixels in the bright state in the row is V1. Due to the capacitive characteristics, the Vcom is pulled up from the theoretical value to an actual value above the theoretical value, resulting in a decrease of the voltage difference of |V1−Vcom|, and hence decreasing the brightness of the displayed image. When the next image frame is displayed, each of the output voltages of the data driving circuits corresponding to all the pixels in the bright state in the row is V14. Due to the capacitive characteristics, the Vcom is pulled down from the theoretical value to an actual value below the theoretical value, resulting in a decrease of the voltage difference of |V14−Vcom|, and hence decreasing the brightness of the displayed image.

In this embodiment, not all polarities of the output voltages of the data driving circuits corresponding to the pixels in the bright state are same, so that the Vcom is not significantly pulled, thereby improving the brightness of the displayed image, so as to solve the above problem. Reference is made to FIG. 1. In the related art, the pixels in the bright state in the same row pulls the Vcom in a same direction (for example, the pixels pull up the Vcom in the case of V1, and the pixels pull down the Vcom in the case of V14), such that there is a great difference between the actual value and the theoretical value of the Vcom. In this embodiment, not all the polarities of the output voltages of the data driving circuits corresponding to the pixels in the bright state in the same row are same, so that the Vcom can be pulled in different directions, and hence the difference between the actual value and the theoretical value of the Vcom is relatively small.

For example, the output voltages of the data driving circuits corresponding to the pixels in the bright state in a row may be the V1 or the V14, and the absolute values of the V1 and the V14 are same and the polarities of V1 and V14 are different. For another example, the output voltages of the data driving circuits corresponding to the pixels in the bright state in a row may be the V2 or the V13, and the absolute values of the V2 and the V13 are same and the polarities of V1 and V14 are different. More such examples are known for a person skilled in the art under the teaching of the above description.

In an embodiment, in a row, absolute values of the output voltages of the data driving circuits corresponding to the pixels in the dark state are same, and not all polarities of the output voltages of the data driving circuits corresponding to the pixels in the dark state are same. If absolute values of the output voltages of the data driving circuits corresponding to the pixels in the bright state are same and not all polarities of the output voltages of the data driving circuits corresponding to the pixels in the bright state are same in the row, and absolute values of the output voltages of the data driving circuits corresponding to the pixels in the dark state are same and not all polarities of the output voltages of the data driving circuits corresponding to the pixels in the dark state are same, then the voltage polarities of the pixels in the row may be easily adjusted, so that not only the voltage different between adjacent pixels is relatively small to reduce the loads on the data driving circuit, but also the Vcom can be pulled in different directions to enable the difference between the actual value and the theoretical value of the Vcom to be small.

For example, the output voltages of the data driving circuits corresponding to the pixels in the dark state in a row may be the V7 or the V8, and the absolute values of the V7 and the V8 are same and the polarities of V7 and V8 are different. For another example, the output voltages of the data driving circuits corresponding to the pixels in the dark state in a row may be the V6 or the V9, and the absolute values of the V6 and the V9 are same and the polarities of V6 and V9 are different.

Alternatively, the output voltages of the data driving circuits corresponding to the pixels in the dark state in a row are same. Such examples are known for a person skilled in the art under the teaching of the present disclosure.

In an embodiment, there is a plurality of pixel groups in the row, and each of the pixel groups comprises at least two pixels. The number of the pixels included in each of the pixel groups may be same. A sequence of the output voltages of the data driving circuits corresponding to the pixels of one of the pixel groups is same as a sequence of the output voltages of the data driving circuits corresponding to the pixels of another one of the pixel groups. Optionally, the at least two pixels in each of the pixel groups are adjacent to each other. Optionally, the number of the pixels in each of the pixel groups is an even number.

In this embodiment, the pixel voltages in the row are periodically changed. Each of the pixel groups includes at least two adjacent pixels for which the polarities of the output voltages of the data driving circuits are same. That is, there are multiple scenarios in a row, and in each of the multiple scenarios, polarities of the output voltages of the data driving circuits corresponding to the adjacent pixels are same, which further reduces the loads on the data driving circuit.

For example, the pixels in each of the pixel groups can meet the following rules. A first rule: there are at least two adjacent pixels where the polarities of output voltages of data driving circuits corresponding to the at least two adjacent pixels are same, and the at least two adjacent pixels include a pixel in the bright state and a pixel in the dark state. A second rule: an absolute value of the output voltage of the data driving circuit corresponding to the pixel in the bright state is greater than an absolute value of the output voltage of the data driving circuit corresponding to the pixel in the dark state. A third rule: in the row, absolute values of the output voltages of the data driving circuits corresponding to the pixels in the bright state are same, and not all polarities of the output voltages of the data driving circuits corresponding to the pixels in the bright state are same.

The number of pixels included in each of the pixel groups is same, and may be equal to 6, 8, 10, etc, which is not limited herein. Take six pixels in the pixel group as an example for illustration. That is, the pixels in a row are periodically changed in the unit of six. It is considered that a first one of the pixel group is a pixel in the bright state, and in the row, absolute values of the output voltages of the data driving circuits corresponding to the pixels in the dark state are same, and not all polarities of the output voltages of the data driving circuits corresponding to the pixels in the dark state are same. Based on this, in an embodiment, the method for driving the pixels in the row may include: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be negative; and controlling a polarity of the output voltage of the data driving circuit corresponding to a sixth pixel in the pixel group to be negative.

In the display process, the pixels in the pixel array are lighted row by row successively. For example, when a display of the pixels in the first row is completed, the pixels in the first row are turned off and the pixels in the second row are turned on, and when a display of the pixels in the second row is completed, the pixels in the second row are turned off and the pixels in the third row are turned on, and so on, which will not be described repeatedly herein. Absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other.

Accordingly, in this embodiment, with respect to in a row next to the current row, a first pixel in a pixel group is also a pixel in the bright state, and the method for driving the pixels in the next row may include: controlling a polarity of the output voltage of the data driving circuit corresponding to the first pixel in the pixel group to be negative; controlling a polarity of the output voltage of the data driving circuit corresponding to a second pixel in the pixel group to be positive; controlling a polarity of the output voltage of the data driving circuit corresponding to a third pixel in the pixel group to be positive; controlling a polarity of the output voltage of the data driving circuit corresponding to a fourth pixel in the pixel group to be negative; controlling a polarity of the output voltage of the data driving circuit corresponding to a fifth pixel in the pixel group to be positive; and controlling a polarity of the output voltage of the data driving circuit corresponding to a sixth pixel in the pixel group to be positive.

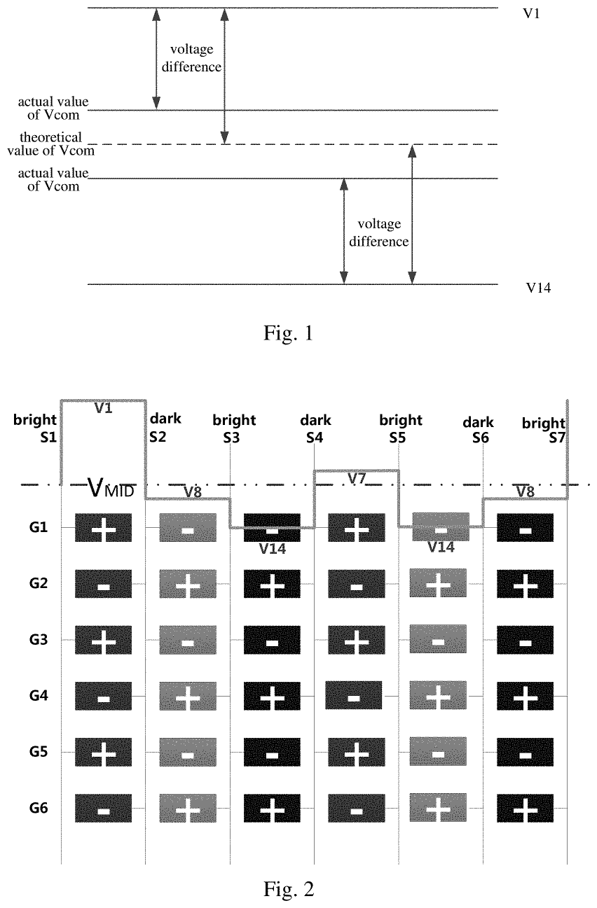

For example, with respect to a row of the pixel array, if each of the output voltages of the data driving circuits corresponding to the pixels in the bright state is either V1 or V14, and each the output voltages of the data driving circuits corresponding to the pixels in the dark state is either V7 or V8, then the sequence of the output voltages in the pixel group of the row may be: V1-V8-V14-V7-V14-V8, as shown in FIG. 2.

As shown in FIGS. 2 to 7, when a sub-v-line heavy-load image is displayed, the display panel may display, in an alternate way, a column of pixels in the bright state, a column of pixels in the dark state, a column of pixels in the bright state, a column of pixels in the dark state, and so on. As shown in FIGS. 2 to 7, each block represents a pixel, S represents a column, G represents a row, and Vmid represents an intermediate voltage. FIGS. 2 to 7 exemplarily shows the voltages V1, V7, V8 and V14, which are output voltages of the data driving circuits corresponding to the respective pixels in each of the odd-numbered rows of the pixel array.

As described above, absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other. That is, the sequence of the voltages with respect to the pixel group of the row G1 is: V1-V8-V14-V7-V14-V8, the sequence of the voltages with respect to the pixel group of row G2 is: V14-V7-V1-V8-V1-V7, the sequence of the voltages with respect to the pixel group of row G3 is: V1-V8-V14-V7-V14-V8, and so on, which may not be described repeatedly herein.

For another example, it is considered that, in a row, each of the output voltages of the data driving circuits corresponding to the pixels in the bright state is either V2 or V13, and each of the output voltages of the data driving circuits corresponding to the pixels in the dark state in the row is either V6 or V9, then the sequence of the voltages with respect to the pixel group of the row may be: V2-V9-V13-V6-V13-V9.

As above, absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other. That is, the sequence of the voltages with respect to the pixel group of the row G1 is: V2-V9-V13-V6-V13-V9, the sequence of the voltages with respect to the pixel group of the row G2 is: V13-V6-V2-V9-V2-V6, the sequence of the voltages with respect to the pixel group of the row G3 is: V2-V9-V13-V6-V13-V9, and so on, which will not be described repeatedly herein.

In another embodiment, six pixels are included in each of the pixel groups for illustration again. It is considered that a first one of the pixel group is a pixel in the bright state, and that in the row, absolute values of the output voltages of the data driving circuits corresponding to the pixels in the dark state are same, and not all polarities of the output voltages of the data driving circuits corresponding to the pixels in the dark state are same. Based on this, the method for driving the pixels in the current row may include: controlling a polarity of the output voltage of the data driving circuit corresponding to the first pixel in the pixel group to be positive; controlling a polarity of the output voltage of the data driving circuit corresponding to a second pixel in the pixel group to be positive; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be positive; and controlling a polarity of the output voltage of the data driving circuit corresponding to a sixth pixel in the pixel group to be negative.

In the display process, the pixels in the rows may be lighted row by row successively. For example, when a display of the pixels in the first row is completed, the pixels in the first row are turned off and the pixels in the second row are turned on, and when a display of the pixels in the second row is completed, the pixels in the second row are turned off and the pixels in the third row are turned on, and so on, which may not be described repeatedly herein. Absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other.

Accordingly, in this embodiment, with respect to a row next to the current row, a first pixel in a pixel group is also a pixel in the bright state, and the method for driving the pixels in the next row may include: controlling a polarity of the output voltage of the data driving circuit corresponding to the first pixel in the pixel group to be negative; controlling a polarity of the output voltage of the data driving circuit corresponding to the second pixel in the pixel group to be negative; controlling a polarity of an output voltage of a data driving circuit corresponding to the third pixel in the pixel group to be positive; controlling a polarity of an output voltage of a data driving circuit corresponding to the fourth pixel in the pixel group to be negative; controlling a polarity of the output voltage of the data driving circuit corresponding to the fifth pixel in the pixel group to be negative; and controlling a polarity of the output voltage of the data driving circuit corresponding to the sixth pixel in the pixel group to be positive.

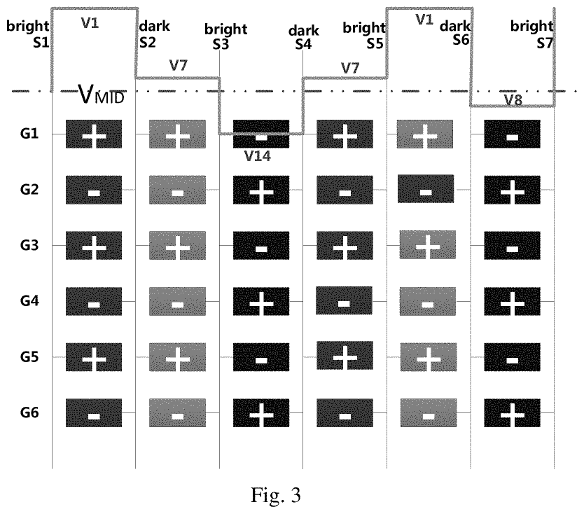

For example, with respect to a row of the pixel array, if each of the output voltages of the data driving circuits corresponding to the pixels in the bright state is either V1 or V14, and each of the output voltages of the data driving circuits corresponding to the pixels in the dark state is either V7 or V8, then the sequence of the output voltages with respect to the pixel group of the row may be: V1-V7-V14-V7-V1-V8, as shown in FIG. 3.

As described above, absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other. That is, the sequence of the voltages with respect to the pixel group of the row G1 is: V1-V7-V14-V7-V1-V8, the sequence of the voltages with respect to the pixel group of row G2 is: V14-V8-V1-V8-V14-V7, the sequence of the voltages with respect to the pixel group of row G3 is: V1-V7-V14-V7-V1-V8, and so on, which will not be described repeatedly herein.

For another example, with respect to a row of the pixel array, if each of the output voltages of the data driving circuits corresponding to the pixels in the bright state is either V2 or V13, and each of the output voltages of the data driving circuits corresponding to the pixels in the dark state is either V6 or V9, then the sequence of the voltages with respect to the pixel group of the row may be: V2-V6-V13-V6-V2-V9.

As described above, absolute values of the output voltages of the data driving circuits corresponding to the pixels located in a same column and respectively in adjacent two rows are same, and polarities of the output voltages of the data driving circuits corresponding to the pixels located in the same column and respectively in adjacent two rows are opposite to each other. That is, the sequence of the voltages with respect to the pixel group of the row G1 is: V2-V6-V13-V6-V2-V9, the sequence of the voltages with respect to the pixel group of the row G2 is: V13-V9-V2-V9-V13-V6, the sequence of the voltages with respect to the pixel group of the row G3 is: V2-V6-V13-V6-V2-V9, and so on, which will not be described repeatedly herein.

In the above embodiments, it is considered that that in the row, absolute values of the output voltages of the data driving circuits corresponding to the pixels in the dark state are same, and not all polarities of the output voltages of the data driving circuits corresponding to the pixels in the dark state are same. In some other embodiments, both absolute values and polarities of the output voltages of the data driving circuits corresponding to the pixels in the dark state in the row may be same. It is assumed that in the row, all the polarities of the output voltages of the data driving circuits corresponding to the pixels in the dark state are positive. Based on this, the driving method corresponding to FIG. 1 may be changed as follows: controlling a polarity of the output voltage of the data driving circuit corresponding to the first pixel in the pixel group to be positive; controlling a polarity of the output voltage of the data driving circuit corresponding to a second pixel in the pixel group to be positive; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be negative; and controlling a polarity of the output voltage of the data driving circuit corresponding to a sixth pixel in the pixel group to be positive.

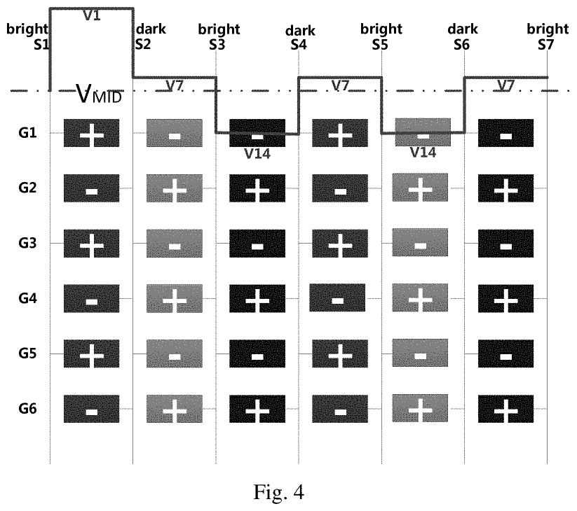

For example, as shown in FIG. 4, the sequence of the voltages with respect to the pixel group may be: V1-V7-V14-V7-V14-V7.

It is assumed that in the row, all the polarities of the output voltages of the data driving circuits corresponding to the pixels in the dark state are negative. Based on this, the driving method corresponding to FIG. 1 may be changed as follows: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be negative; controlling a polarity of the output voltage of the data driving circuit corresponding to a fifth pixel in the pixel group to be negative; and controlling a polarity of the output voltage of the data driving circuit corresponding to a sixth pixel in the pixel group to be negative.

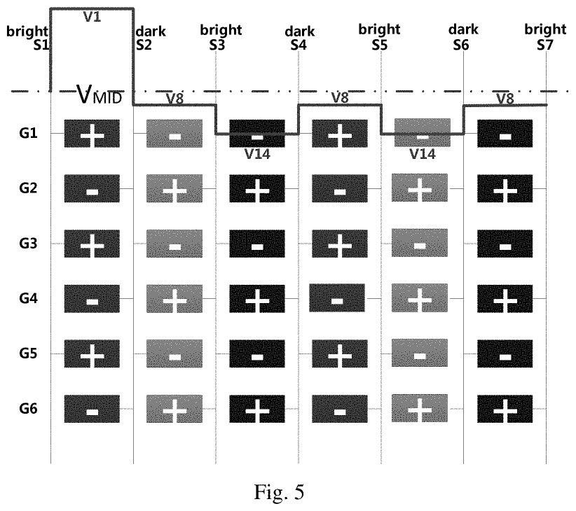

For example, as shown in FIG. 5, the sequence of the voltages with respect to the pixel group may be: V1-V8-V14-V8-V14-V8.

It is assumed that in the row, all the polarities of the output voltages of the data driving circuits corresponding to the pixels in the dark state are positive. Based on this, the driving method corresponding to FIG. 2 may be changed as follows: controlling a polarity of the output voltage of the data driving circuit corresponding to the first pixel in the pixel group to be positive; controlling a polarity of the output voltage of the data driving circuit corresponding to a second pixel in the pixel group to be positive; controlling a polarity of the output voltage of the data driving circuit corresponding to a third pixel in the pixel group to be negative; controlling a polarity of the output voltage of the data driving circuit corresponding to a fourth pixel in the pixel group to be positive; controlling a polarity of the output voltage of the data driving circuit corresponding to a fifth pixel in the pixel group to be positive; and controlling a polarity of the output voltage of the data driving circuit corresponding to a sixth pixel in the pixel group to be positive.

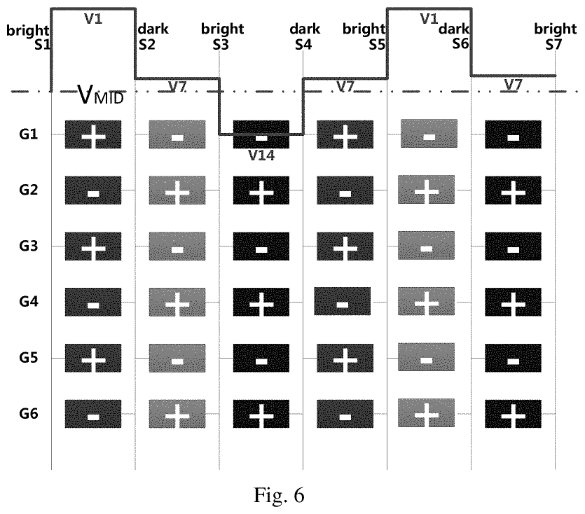

For example, as shown in FIG. 6, the sequence of the voltages with respect to the pixel group may be: V1-V7-V14-V7-V1-V7.

It is assumed that in the row, all the polarities of the output voltages of the data driving circuits corresponding to the pixels in the dark state are positive. Based on this, the driving method corresponding to FIG. 2 may be changed as follows: controlling a polarity of the output voltage of the data driving circuit corresponding to the first pixel in the pixel group to be positive; controlling a polarity of the output voltage of the data driving circuit corresponding to a second pixel in the pixel group to be negative; controlling a polarity of the output voltage of the data driving circuit corresponding to a third pixel in the pixel group to be negative; controlling a polarity of the output voltage of the data driving circuit corresponding to a fourth pixel in the pixel group to be negative; controlling a polarity of the output voltage of the data driving circuit corresponding to a fifth pixel in the pixel group to be positive; and controlling a polarity of the output voltage of the data driving circuit corresponding to a sixth pixel in the pixel group to be negative.

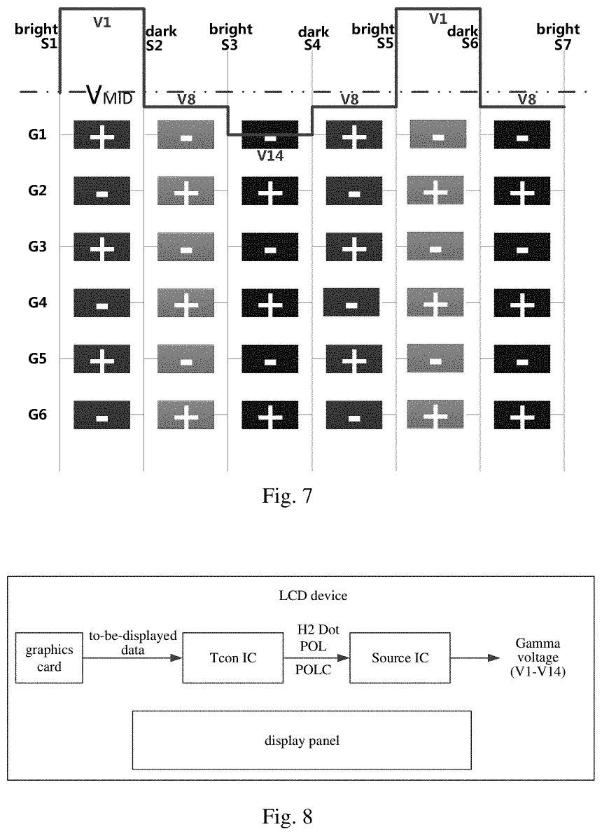

For example, as shown in FIG. 7, the sequence of the voltages with respect to the pixel group may be: V1-V8-V14-V8-V1-V8.

It can be known from above that the pixels in each of the pixel groups only need to meet the above three rules. More such examples are known for a person skilled in the art under the teaching of the above description.

An embodiment of the present disclosure further provides a device for driving a display panel. The device for driving the display panel includes: a timing control circuit and a data driving circuit corresponding to each of the pixels. The timing control circuit is configured to execute any one of the methods described above.

An embodiment of the present disclosure further provides a LCD device. As shown in FIG. 8, the LCD device includes: a display panel, a graphics card, a timing control circuit, and a data driving circuit corresponding to each of the pixels. The graphics card is configured to transmit to-be-displayed data to the timing control circuit. The timing control circuit is configured to determine whether the to-be-displayed data corresponds to a sub-v-line heavy-load image; and when the to-be-displayed data corresponds to the sub-v-line heavy-load image, implement the any one of the methods described above.

Referring to FIG. 8, the graphics card (e.g., a Graphics Processing Unit (GPU)) in the LCD device may be used to transmit the to-be-displayed data to a Timing controller Integrated Circuit (Tcon IC). The Tcon IC may analyze and determine whether the to-be-displayed data is for a heavy-load image. If it is, the Source IC (that is, the data driving circuit) may be adjusted by adjusting a Polarity control (POL) signal, a Horizontal 2-dot inversion (H2Dot) signal, and a Determined POL inversion (POLC) signal, such that the source IC outputs a gamma voltage according to any one of the embodiments of the present disclosure.

Optionally, the display panel includes: an array substrate including a TFT and a pixel array; an opposite substrate including a color filter and/or a black matrix; and a liquid crystal layer arranged between the array substrate and the counter substrate.

For example, different forms of inversion (column inversion, row inversion, dot inversion, etc.) correspond to different heavy-load images. The logics of various heavy-load images may be written into the Tcon IC in advance. In this way, Tcon IC may analyze to determine whether the to-be-displayed data is a heavy-load image, through the logics of various heavy-load images.

The above embodiments are described in a related manner, and the same or similar portions between the various embodiments may be referred to each other. Each of the embodiments focuses on the difference portions from other embodiments. In particular, for an embodiment of the driving device and an embodiment of the LCD device, since they are substantially similar to embodiments of the driving method shown FIGS. 1 to 7, the description thereof is relatively simple, and the related or similar portions thereof may refer to the corresponding description of the embodiments of the driving method shown in FIGS. 1 to 7.

A person skilled in the art should understand that the discussion of any of the above embodiments is merely exemplary, and is not intended to imply that the scope of the present disclosure including claims is limited to these examples; under the concept of the present disclosure, the above embodiments or the technical features in different embodiments may also be combined with each other, the steps may be implemented in any order, and there are many other variations of different aspects of the present disclosure as described above, which are not provided in the details for the sake of brevity.

In addition, to simplify the description and discussion, and to facilitate to understand the present disclosure, known power source connections/ground connections to IC chips and other components may or may not be shown in the drawings. In addition, the devices may be shown in block diagram in order to facilitate to understand the present disclosure, and this also takes into account the fact that details regarding the implementation of the device in these block diagrams are highly dependent on the platform on which the present disclosure may be implemented (i.e. these details should be completely within the understanding of a person skilled in the art). Where specific details (e.g, a circuit) are set forth to describe exemplary embodiments of the present disclosure, it may be apparent to a person skilled in the art that the present disclosure may be implemented without the specific details or with changes in the specific details. Therefore, these specific details should be considered as being illustrative and not restrictive.

Although the present disclosure has been described in connection with specific embodiments of the present disclosure, many substitutions, modifications, and variations of these embodiments will be apparent to a person skilled in the art based on the foregoing description. For example, other memory architectures (for example, a Dynamic Random Access Memory (DRAM)) may be applied to the embodiments discussed.

The embodiments of the present disclosure are intended to cover all such alternatives, modifications, and variations that fall within the broad scope of the appended claims. Thus, any omissions, modifications, equivalent substitutions, improvements within the spirit and principle of the present disclosure, are all included within the protection scope of the present disclosure.

What is claimed is:

1. A method for driving a display panel, comprising:
controlling polarities of output voltages of data driving circuits corresponding to at least two adjacent pixels in a row of a pixel array of the display panel to be same,
wherein the adjacent pixels comprise a pixel in a bright state and a pixel in a dark state, and an absolute value of the output voltage of the data driving circuit corresponding to the pixel in the bright state is greater than an absolute value of the output voltage of the data driving circuit corresponding to the pixel in the dark state.

2. The method according to claim 1, wherein in the row of the pixel array, absolute values of the output voltages of the data driving circuits corresponding to the pixels in the bright state are the same, and not all polarities of the output voltages of the data driving circuits corresponding to the pixels in the bright state are the same.

3. The method according to claim 2, wherein there is a plurality of pixel groups in the row, wherein each of the pixel groups comprises at least two pixels, and
a sequence of the output voltages of the data driving circuits corresponding to at least two pixels of a first one of the pixel groups is the same as a sequence of the output voltages of the data driving circuits corresponding to at least two pixels of a second one of the pixel groups.

4. The method according to claim 3, wherein the pixels in each of the pixel groups are adjacent to each other, and the number of the pixels in each of the pixel groups is an even number.

5. The method according to claim 3, wherein in the row of the pixel array, absolute values of the output voltages of the data driving circuits corresponding to the pixels in the dark state are the same, and not all polarities of the output voltages of the data driving circuits corresponding to the pixels in the dark state are the same.

6. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be negative;
controlling a polarity of the output voltage of the data driving circuit corresponding to a third pixel in the pixel group to be negative;
controlling a polarity of the output voltage of the data driving circuit corresponding to a fourth pixel in the pixel group to be positive;
controlling a polarity of the output voltage of the data driving circuit corresponding to a fifth pixel in the pixel group to be negative; and
controlling a polarity of the output voltage of the data driving circuit corresponding to a sixth pixel in the pixel group to be negative.

7. The method according to claim 6, wherein the pixel array further comprises a neighboring row adjacent to the row, and the method further comprises:
controlling a polarity of the output voltage of the data driving circuit corresponding to a pixel in the neighboring row adjacent to the first pixel to be negative;
controlling a polarity of the output voltage of the data driving circuit corresponding to a pixel in the neighboring row adjacent to the second pixel to be positive;
controlling a polarity of an output voltage of a data driving circuit corresponding to a pixel in the neighboring row adjacent to the third pixel to be positive;
controlling a polarity of an output voltage of a data driving circuit corresponding to a pixel in the neighboring row adjacent to the fourth pixel to be negative;
controlling a polarity of the output voltage of the data driving circuit corresponding to a pixel in the neighboring row adjacent to the fifth pixel to be positive; and
controlling a polarity of the output voltage of the data driving circuit corresponding to a pixel in the neighboring row adjacent to the sixth pixel to be positive.

8. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be positive;
controlling a polarity of the output voltage of the data driving circuit corresponding to a third pixel in the pixel group to be negative;
controlling a polarity of the output voltage of the data driving circuit corresponding to a fourth pixel in the pixel group to be positive;
controlling a polarity of the output voltage of the data driving circuit corresponding to a fifth pixel in the pixel group to be positive; and
controlling a polarity of the output voltage of the data driving circuit corresponding to a sixth pixel in the pixel group to be negative.

9. The method according to claim 8, wherein the pixel array further comprises a neighboring row adjacent to the row, and the method further comprises:
controlling a polarity of the output voltage of the data driving circuit corresponding to a pixel in the neighboring row adjacent to the first pixel to be negative;
controlling a polarity of the output voltage of the data driving circuit corresponding to a pixel in the neighboring row adjacent to the second pixel to be negative;
controlling a polarity of an output voltage of a data driving circuit corresponding to a pixel in the neighboring row adjacent to the third pixel to be positive;
controlling a polarity of an output voltage of a data driving circuit corresponding to a pixel in the neighboring row adjacent to the fourth pixel to be negative;
controlling a polarity of the output voltage of the data driving circuit corresponding to a pixel in the neighboring row adjacent to the fifth pixel to be negative; and
controlling a polarity of the output voltage of the data driving circuit corresponding to a pixel in the neighboring row adjacent to the sixth pixel to be positive.

10. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be positive;
controlling a polarity of the output voltage of the data driving circuit corresponding to a third pixel in the pixel group to be negative;
controlling a polarity of the output voltage of the data driving circuit corresponding to a fourth pixel in the pixel group to be positive;
controlling a polarity of the output voltage of the data driving circuit corresponding to a fifth pixel in the pixel group to be negative; and
controlling a polarity of the output voltage of the data driving circuit corresponding to a sixth pixel in the pixel group to be positive.

11. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be negative;
controlling a polarity of the output voltage of the data driving circuit corresponding to a third pixel in the pixel group to be negative;
controlling a polarity of the output voltage of the data driving circuit corresponding to a fourth pixel in the pixel group to be negative;
controlling a polarity of the output voltage of the data driving circuit corresponding to a fifth pixel in the pixel group to be negative; and
controlling a polarity of the output voltage of the data driving circuit corresponding to a sixth pixel in the pixel group to be negative.

12. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be positive;
controlling a polarity of the output voltage of the data driving circuit corresponding to a third pixel in the pixel group to be negative;
controlling a polarity of the output voltage of the data driving circuit corresponding to a fourth pixel in the pixel group to be positive;
controlling a polarity of the output voltage of the data driving circuit corresponding to a fifth pixel in the pixel group to be positive; and
controlling a polarity of the output voltage of the data driving circuit corresponding to a sixth pixel in the pixel group to be positive.

13. The method according to claim 5, wherein each of the pixel groups comprises six pixels, and a first pixel of the six pixels is a pixel in the bright state; and
controlling the polarities of the output voltages of the data driving circuits corresponding to the at least two adjacent pixels in the row to be the same comprises:
controlling a polarity of the output voltage of the data driving circuit corresponding to the first pixel in the pixel group to be positive;
controlling a polarity of the output voltage of the data driving circuit corresponding to a second pixel in the pixel group to be negative;
controlling a polarity of the output voltage of the data driving circuit corresponding to a third pixel in the pixel group to be negative;
controlling a polarity of the output voltage of the data driving circuit corresponding to a fourth pixel in the pixel group to be negative;
controlling a polarity of the output voltage of the data driving circuit corresponding to a fifth pixel in the pixel group to be positive; and
controlling a polarity of the output voltage of the data driving circuit corresponding to a sixth pixel in the pixel group to be negative.

14. The method according to claim 1, wherein:
the output voltage of the data driving circuit is in a range of gamma voltages V1-V14, wherein a polarity of each of the gamma voltages V1-V7 is positive, and a polarity of each of the gamma voltages V8-V14 is negative;
the output voltage of the data driving circuit corresponding to the pixel in the bright state is the gamma voltage V1 or the gamma voltage V14; and
the output voltage of the data driving circuit corresponding to the pixel in the dark state is the gamma voltage V7 or the gamma voltage V8.

15. The method according to claim 1, wherein absolute values of the output voltages of the data driving circuits corresponding to the pixels located in a same column and respectively in adjacent two rows of the pixel array are the same, and polarities of the output voltages of the data driving circuits corresponding to the pixels located in the same column and respectively in the adjacent two rows of the pixel array are opposite to each other.

16. The method according to claim 1, wherein a heavy-load image having columns of the pixels in the bright state alternated with columns of the pixels in the dark state in the pixel array is displayed by using a Z-inversion mode, and
in the row, the pixels in the bright state are alternately arranged with the pixels in the dark state.

17. A device for driving a display panel, comprising: a timing control circuit and a data driving circuit corresponding to each of the pixels, wherein the timing control circuit is configured to execute the method according to claim 1.

18. The device for driving the display panel according to claim 17, wherein in the row of the pixel array, absolute values of the output voltages of the data driving circuits corresponding to the pixels in the bright state are the same, and not all polarities of the output voltages of the data driving circuits corresponding to the pixels in the bright state are the same.

19. The device for driving the display panel according to claim 18, wherein there is a plurality of pixel groups in the row, wherein each of the pixel groups comprises at least two pixels, and
a sequence of the output voltages of the data driving circuits corresponding to at least two pixels of one of the pixel groups is same as a sequence of the output voltages of the data driving circuits corresponding to at least two pixels of another one of the pixel groups.

20. A Liquid Crystal Display (LCD) device, comprising: a display panel, a graphics card, a timing control circuit, and a data driving circuit corresponding to each of the pixels;
wherein the graphics card is configured to transmit to-be-displayed data to the timing control circuit; and
wherein the timing control circuit is configured to determine whether the to-be-displayed data corresponds to a heavy-load image having columns of pixels in a bright state alternated with columns of pixels in a dark state, and in response to the to-be-displayed data corresponding to the heavy-load image having the columns of the pixels in the bright state alternated with the columns of the pixels in the dark state, implement the method according to claim 1.
